(19) United States
(12) Patent Application Publication
(10) Pub. No.: US 2018/0273720 A1
(43) Pub. Date: Sep. 27, 2018

(54) PARTICULATE MIXTURES

(71) Applicant: Hewlett-Packard Development Company, L.P., Houston, TX (US)

(72) Inventors: Wei Huang, Palo Alto, CA (US); Lihua Zhao, Palo Alto, CA (US); Yan Zhao, Palo Alto, CA (US); Jun Zeng, Palo Alto, CA (US)

(73) Assignee: Hewlett-Packard Development Company, L.P., Houston, TX (US)

(21) Appl. No.: 15/763,359

(22) PCT Filed: Oct. 9, 2015
(86) PCT No.: PCT/US2015/054913

§ 371 Date: Mar. 26, 2018

(51) Int. Cl. C08K 3/16; B33Y 10/00; B33Y 70/00; B29C 64/165

(52) U.S. Cl. CPC C08K 3/16; B33Y 10/00; B29K 2077/10; B29C 64/165; B33Y 70/00

(57) ABSTRACT

The present disclosure is drawn to particulate mixtures, material sets and methods of forming porous 3-dimensional printed parts. The particulate mixtures can include 5 wt % to 40 wt % of a salt having an average particle size from 5 μm to 100 μm. The mixture can also include 60 wt % to 95 wt % of a build material for 3-dimensional printing. The build material can include a particulate polymer having an average particle size from 5 μm to 100 μm and a melting point from 100° C. to 400° C. The melting point of the particulate polymer can be lower than the melting point of the salt.

### BACKGROUND

Methods of 3-dimensional (3D) digital printing, which is a type of additive manufacturing, have continued to be developed over the last few decades. However, systems for 3D printing have historically been very expensive, though those expenses have been coming down to more affordable levels recently. In general, 3D printing technology improves the product development cycle by allowing rapid creation of prototype models for reviewing and testing, in one example. Unfortunately, the concept has been somewhat limited with respect to commercial production capabilities because the range of materials used in 3D printing is likewise limited. Nevertheless, several commercial sectors such as aviation and the medical industry have benefitted from the ability to rapidly prototype and customize parts for customers.

Various methods for 3D printing have been developed, including heat-assisted extrusion, selective laser sintering, photolithography, as well as others. Several methods of “powder bed” 3D printing have been developed. In these methods, 3D parts can be printed by spreading a thin layer of a powder or particulate material, and then selectively binding or melting a portion of the material to form a solid cross section. For example, in selective laser sintering, a powder bed is exposed to point heat from a laser to melt the powder wherever the cross section is to be formed. Then, additional layers of powder can be spread over the first layer and the 3D part can be built up of many solid cross sections.

### BRIEF DESCRIPTION OF THE DRAWINGS

FIG. 1 shows an enlarged cross-sectional view of a particulate mixture in accordance with examples of the present technology;

FIG. 2 shows an enlarged cross-sectional view of a particulate mixture in accordance with examples the present technology;

FIG. 3 is a flowchart illustrating a method of forming a porous 3-dimensional printed part in accordance with examples of the present technology;

FIG. 4A shows a particulate mixture bed printed with a coalescent ink and irradiated with electromagnetic radiation in accordance with examples of the present technology;

FIG. 4B shows a fused polymer with embedded salt particles in accordance with examples of the present technology; and

FIG. 4C shows a 3-dimensional printed part after dissolving the salt particles to leave pores in the 3-dimensional printed part in accordance with examples of the present technology.

### DETAILED DESCRIPTION

The present disclosure is drawn to the area of 3-dimensional printing. More specifically, the present disclosure provides particulate mixtures, material sets, and methods for printing porous 3-dimensional parts.

Porous structures can have many uses in a variety of areas. For example, porous materials are useful in the energy industry, including the petroleum and fuel cell industries, the construction industry, the biomedical industry, geoscience, and others. Current additive manufacturing methods can be used to create 3-dimensional printed parts with bulk scale porous structures by designing pores in the geometry of the part to be printed using computer-aided design (CAD) software. However, these methods are limited by the available printing resolution. These methods may not be able to make printed parts having micro-scale porosity, such as pores less than 1 mm in diameter. Therefore, existing methods have limited ability to make 3-dimensional printed parts with very small pore sizes.

The present technology provides methods of 3-dimensional printing porous structures with small pores without being particularly limited by printing resolution. Using these methods, porous materials can be created with pore sizes smaller than is currently possible or typical by CAD manipulation. According to the present technology, a soluble particulate material can be mixed with a build material. This mixture can be used to form the 3-dimensional printed part. After the part has been formed, the soluble particulate material can be dissolved using a suitable solvent for that particular soluble particulate. The volumes previously occupied by the soluble particulate material then become pores in the printed part. The porosity and pore size can be adjusted by changing the amount and particle size of the soluble particulate material.

In some examples, the final porous 3-dimensional printed part can have a substantially continuous network of pores distributed throughout the part. This can be accomplished by using a sufficient amount of soluble particulate material that particles of the soluble material touch or nearly touch adjacent particles. The touching or nearly touching particles of soluble material provide a pathway for the solvent to reach and dissolve a majority of the particles of soluble material. In some cases, if too little soluble particulate material is used, then some particles of the soluble particulate material can become trapped inside the non soluble build material so that the solvent cannot access the particles. On the other hand, using a large amount of soluble particulate material can increase the porosity of the printed part to the point that the structural integrity of the printed part can be compromised. Therefore, the amount of soluble particulate material in relation to the amount of build material can be adjusted to achieve a desired porosity and structural strength of the final printed part.

The present technology can be applied to a variety of 3-dimensional printing methods. For example, any method of 3-dimensional printing using a powder bed can be performed using a powder bed comprising a soluble particulate material mixed with a particulate build material. This type of mixture can be used in binder jetting 3-dimensional printing systems, Multi Jet Fusion™ systems, selective laser sintering (SLS) systems, selective laser melting (SLM) systems, electron beam melting (EBM) systems, and other 3-dimensional printing methods involving a bed of particulate material. Thus, a variety of 3-dimensional printing methods can be used to form porous printed parts using the present technology.

In certain examples, the present technology can be applied to a Multi Jet Fusion™ system. A thin layer of polymer powder is spread on a bed to form a powder bed. A printing head, such as an inkjet print head, is then used to print a coalescent ink over portions of the powder bed corresponding to a thin layer of the three dimensional object to be formed. Then the bed is exposed to a light source, e.g., typically the entire bed. The coalescent ink absorbs more energy from the light than the unprinted powder. The absorbed light energy is converted to thermal energy, causing the printed portions of the powder to melt and coalesce. This forms a solid layer. After the first layer is formed, a new thin layer of polymer powder is spread over the powder bed and the process is repeated to form additional layers until a complete 3D part is printed. In accordance with the present technology, such a Multi Jet Fusion™ process can achieve fast throughput with good accuracy.

In an example of the present technology, a mixture of a soluble particulate salt with a particulate polymer build material can be used in a Multi Jet Fusion™ process. A thin layer of the mixture of salt and polymer particles can be spread over the bed, and then printed with a coalescent ink on the desired area to be fused. The bed can then be irradiated to fuse the printed portion. This can cause the polymer particles to fuse, embedding salt particles within the fused polymer. The salt can be chosen to have a higher melting temperature than the polymer particles, so that the salt does not melt during this step. The unmelted salt particles act as place-holders for pores. The steps of spreading a layer of the particulate mixture, printing coalescent ink, and irradiating the bed can be repeated to form multiple layers until a 3-dimensional printed part having salt particles embedded therein is complete. After the part is complete, the part can be soaked in water to dissolve the salt. As the salt particles dissolve, empty pores are left behind in the printed part.

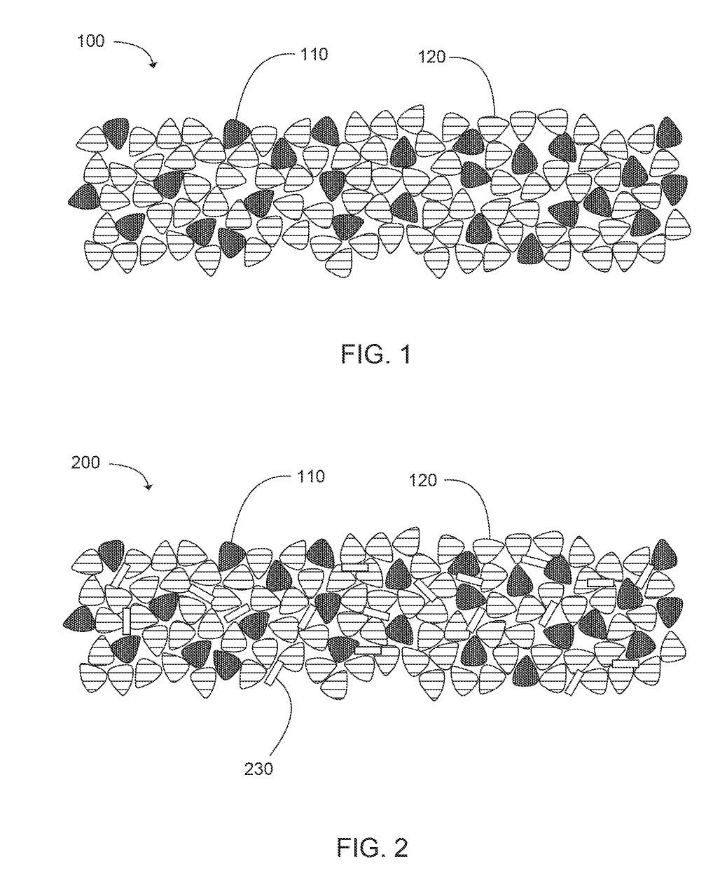

With this description in mind, FIG. 1 shows an enlarged cross-sectional view of an example of a particulate mixture 100 in accordance with the present technology. The particulate mixture includes salt particles 110 and polymer particles 120. This particulate mixture can be a loose mixture. For 3-dimensional printing using a Multi Jet Fusion™ process or other similar process, a thin layer of the particulate mixture can be spread across a bed to provide material for forming a layer of a 3-dimensional printed part.

In some examples, the salt and the particulate polymer can be well mixed so that salt particles are roughly evenly distributed among polymer particles. On the scale of individual particles, the distribution can be random. However, on a larger scale, such as the millimeter scale, the composition of the mixture can be roughly uniform across the entire bed.

Generally, the particle size of the salt and the particle size of the particulate polymer can each range from 5 μm to 100 μm. In certain examples, the particle size of the salt and the particle size of the particulate polymer can each range from 10 μm to 80 μm, or from 10 μm to 60 μm. In some examples, the salt particles and polymer particles can have approximately the same size. Specifically, the salt particles can have an average particle size that is within about a 10% difference from the average particle size of the particulate polymer. In other examples, the salt and particulate polymer can have significantly different particle sizes. In a particular example, the salt particles can be larger than the polymer particles. In specific examples, the salt particles can have an average particle size that is from about 1.1 to about 10 times the average particle size of the particulate polymer. The salt particle size and geometry can determine the pore size and geometry. Therefore, salt particle size and geometry can affect thermal, mechanical, acoustic and other properties of the resulting printed part. The salt particle size and particulate polymer particle size can be selected to provide desired part properties, ease of salt removal, desired loose powder packing density, and so forth.

The relative amounts of salt and particulate polymer can vary depending on the desired porosity and structural strength of the final 3-dimensional printed part. More salt can increase the porosity while potentially decreasing the structural strength of the part. Less salt can reduce the porosity of the part. Additionally, below a certain salt fraction, the salt particles can become trapped within fused polymer so that the fused polymer forms a fluid-tight barrier around the salt particles. If this occurs, then the trapped salt particle cannot be dissolved by soaking the printed part in a solvent after printing. Accordingly, in some examples the relative amounts of salt and particulate polymer can be selected so that a majority of the salt particles are in contact with an adjacent salt particle. This can provide pathways for solvent to reach and dissolve a majority of the salt particles in the 3-dimensional printed part.

Generally, the particulate mixture can contain less salt, by weight, than particulate polymer. In some examples, the mixture can contain from 5 wt % to 40 wt % salt and from 60 wt % to 95 wt % of the particulate polymer. In further examples, the mixture can contain from 10 wt % to 30 wt % salt and from 70 wt % to 90% particulate polymer. In more specific examples, the mixture can contain from 15 wt % to 25 wt % salt and from 75 wt % to 85 wt % particulate polymer. In terms of a weight ratio of salt to particulate polymer, in some examples the ratio of salt to particulate polymer can be from about 1:20 to about 2:3.

Although FIG. 1 shows a two-part mixture of salt with particulate polymer, in certain more general cases, the salt can be mixed with a build material that comprises the particulate polymer. Thus, the build material can also include other ingredients besides the particulate polymer. For example, the build material can include filler such as glass powder, carbon fibers, aluminum powder, graphene, ceramic powder, metal oxides such as TiO₂ and/or Al₂O₃, hybrid materials, or mixtures thereof. These fillers can be added to change the structural or other properties of the 3-dimensional printed part. Generally, the build material can include any solid materials that remain in the final printed part after the salt has been dissolved and removed. The build material and salt can be present in the mixture in any of the relative amounts and ratios described above.

FIG. 2 shows an enlarged cross-sectional view of another example of a particulate mixture 200 in accordance with the present technology. This particulate mixture includes a salt 110 mixed with a build material. The build material includes polymer particles 120 and filler particles 230. The salt particles, polymer particles, and filler particles can be uniformly mixed as described above. Thus, in some examples of the present technology the build material can include both a particulate polymer and a filler. In certain examples, the build materials can include the particulate polymer and the filler only. In other examples, the build material can include the particulate polymer only. In further examples, the build material can include the particulate polymer, the filler, and additional additives.

The particulate polymer can be any polymer that can be fused by heating or solidified by addition of binding materials. In the Multi Jet Fusion™ process or other similar process that uses a particulate powder, the particulate polymer that has been printed with coalescent ink can be irradiated with a wavelength of electromagnetic radiation that is absorbed by the coalescent ink. The absorbed energy is converted into thermal energy, heating the coalescent ink and the particulate polymer. The particulate polymer can be heated to or near a melting point of the particulate polymer, so that the polymer particles fused to each other. In some examples, the particulate polymer can have a melting point from about 100° C. to about 400° C. In further examples the particulate polymer can have a melting point from about 120° C. to about 350° C.

Although melting point is often described herein as the temperature for coalescing the particulate polymer, in some cases the polymer particles can coalesce or be sintered together at temperatures slightly below the melting point. Therefore, as used herein “melting point” can include temperatures slightly lower, such as up to about 20° C. lower, than the actual melting point.

In some examples, the particulate polymer can be a polymer powder. In one example, the polymer powder can have an average particle size from 10 to 100 microns. The particles can have a variety of shapes, such as substantially spherical particles or irregularly-shaped particles. In some examples, the polymer powder can be capable of being formed into 3-dimensional printed parts with a resolution of 10 to 1000 microns. As used herein, “resolution” refers to the size of the smallest feature that can be formed on a 3D printed part. The polymer powder can form layers from about 10 to about 1000 microns thick, allowing the coalesced layers of the printed part to have roughly the same thickness. This can provide a resolution in the z-axis direction of about 10 to about 1000 microns. The polymer powder can also have a sufficiently small particle size and sufficiently regular particle shape to provide about 10 to about 1000 micron resolution along the x-axis and y-axis.

In some examples, the particulate polymer can be colorless. For example, the particulate polymer can have a white, translucent, or transparent appearance. In combination with a coalescing ink having an invisible near-infrared dye and no additional colorant, this can provide a printed part that is white, translucent, or transparent. In other examples, the particulate polymer can be colored for producing colored parts. In still other examples, when the polymer powder is white, translucent, or transparent, color can be imparted to the part by the coalescent ink or other ink, as described herein.

In some cases, the particulate polymer can include nylon 6 powder, nylon 9 powder, nylon 11 powder, nylon 12 powder, nylon 66 powder, nylon 612 powder, polyethylene powder, thermoplastic polyurethane powder, polypropylene powder, polyester powder, polycarbonate powder, polyether ketone powder, polyacrylate powder, polystyrene powder, or mixtures thereof. These examples are non-limiting, and in other examples any fusable particulate polymer can be used.

In addition to the particulate polymer, the build material can optionally include a filler. The filler can be a solid particulate material that remains in the final printed part after dissolving the salt particles. Therefore, the filler can be a material that is not soluble in the solvent used to dissolve the salt. Additionally, in some examples, the filler can have a melting point that is higher than the melting point of the particulate polymer. Thus, the particulate polymer can fuse while the filler particles remain solid and become embedded in the fused polymer. The average particle size of the filler particles can range from about 5 μm to about 60 μm. In some examples, the filler particles can be roughly the same size as the polymer particles. Specifically, the filler particles can have an average size that is within about 10% of the average particle size of the polymer particles. In other examples, the filler particles can be larger or smaller than the polymer particles.

Salts used in the particulate mixture can include any solid salt having a melting temperature above the melting temperature of the particulate polymer. The salt can be soluble in a solvent in which the build material is not soluble. For example, the salt can be water soluble while the build material is not water soluble. This allows the printed part to be soaked in the solvent to dissolve the salt particles while leaving the fused build material structure intact. In other examples, the salt can be soluble in other solvents, such as alcohol. In one specific example, the salt can have a solubility in water of at least 10 g salt/100 mL water at 20° C. In various examples, the salt can include magnesium chloride (MgCl₂; melting point: 714° C.), sodium chloride (NaCl; melting point: 801° C.), sodium aluminate (NaAlO₂; melting point: 1800° C.), potassium nitrate (KNO₃; melting point: 334° C.), magnesium sulfate (MgSO₄; melting point: 1,124° C.), sodium sulfate (Na₂SO₄; melting point: 884° C.), calcium nitrate (Ca(NO₃)₂; melting point: 561° C.), or mixtures thereof.

As described above, the particulate mixture including salt and build material can be placed as a thin layer on a bed of a Multi Jet Fusion™ 3-dimensional printing system or other similar system. A coalescent ink can then be printed on a portion of the particulate mixture layer. The coalescent ink can include water and a colorant. In some examples, the colorant can have a peak absorption at or near a wavelength of electromagnetic radiation used to fuse the particulate polymer in the build material. In some cases the colorant can be a black colorant that strongly absorbs visible light, converting the light energy into heat. In other cases, the colorant can absorb other wavelengths, such as near-infrared or infrared radiation. In certain examples, the coalescent ink can include both a colorant for absorbing radiation to fuse the particulate polymer and a second colorant for imparting a visible color to the particulate polymer. Multiple colors of such coalescent ink can be used to print multicolored 3-dimensional objects. The colorants can include dyes, pigments, or both.

In certain examples, the coalescent ink can include near-infrared dyes to absorb and convert near-infrared light energy to thermal energy. These near-infrared dyes can absorb light wavelengths in the range of about 800 nm to 1400 nm and convert the absorbed light energy to thermal energy. When used with a light source that emits a wavelength in this range and a particulate polymer that has a low absorbance in this range, the near-infrared dye causes the printed portions of the particulate polymer to melt and coalesce without melting the remaining particulate polymer. Thus, near-infrared dyes can be just as efficient or even more efficient at generating heat and coalescing the particulate polymer when compared to carbon black (which is also effective at absorbing light energy and heating up the printed portions of the particulate bed, but has the disadvantage of always providing black or gray parts in color).

In further examples, coalescent inks can be formulated with near-infrared dyes so that the near-infrared dye has substantially no impact on the apparent color of the ink. This allows the formulation of colorless coalescent inks that can be used to coalesce the particulate polymer but which will not impart noticeably visible color to the particulate polymer. Alternatively, the coalescent inks can include additional pigments and/or dyes to give the inks a color such as cyan, magenta, yellow, blue, green, orange, violet, black, etc. Such colored coalescent inks can be used to print colored 3-dimensional parts with acceptable optical density. The coalescent inks can also be formulated with near-infrared dyes that are stable in the ink vehicle and that provide good ink jetting performance. The near-infrared dyes can also be compatible with the particulate polymer so that jetting the ink onto the polymer powder provides adequate coverage and interfiltration of the dyes into the powder.

Near-infrared dyes that can be used in the coalescent ink can include tertiary amine near-infrared dyes, tetraphenyldiamine near-infrared dyes, aminium dyes, tetraaryldiamine dyes, cyanine dyes, dithiolene dyes, or combinations thereof. These dyes are non-limiting and other dyes or pigments can also be used to absorb radiation energy to fuse the particulate polymer.

In some examples, the concentration of near-infrared dye in the coalescent ink can be from 0.1 wt % to 25 wt %. In one example, the concentration of near-infrared dye in the coalescent ink can be from 0.1 wt % to 15 wt %. In another example, the concentration can be from 0.1 wt % to 10 wt %. In yet another example, the concentration can be from 0.5 wt % to 5 wt %.

The concentration can be adjusted to provide a coalescent ink in which the visible color of the coalescent ink is not substantially altered by the near-infrared dye. Although near-infrared dyes generally have very low absorbance in the visible light range, the absorbance is usually greater than zero. Therefore, the near-infrared dyes can typically absorb some visible light, but their color in the visible spectrum is minimal enough that it does not substantially impact the inks ability to take on another color when a colorant is added (unlike carbon black which dominates the inks color with gray or black tones). The pure dyes in powder form can have a visible color, such as light green, light brown or other colors depending on the absorption spectrum of the specific dye. Concentrated solutions of the dyes can also have a visible color. Accordingly, the concentration of the near-infrared dye in the coalescent ink can be adjusted so that the dye is not present in such a high amount that it alters the visible color of the coalescent ink. For example, a near-infrared dye with a very low absorbance of visible light wavelengths can be included in greater concentrations compared to a near-infrared dye with a relatively higher absorbance of visible light. These concentrations can be adjusted based on a specific application with some experimentation.

In further examples, the concentration of the near-infrared dye can be high enough that the near-infrared dye impacts the color of the coalescent ink, but low enough that when the ink is printed on a particulate polymer, the near-infrared dye does not impact the color of the particulate polymer. The concentration of the near-infrared dye can be balanced with the amount of coalescent ink that is to be printed on the particulate polymer so that the total amount of dye that is printed onto the particulate polymer is low enough that the visible color of the particulate polymer is not impacted. In one example, the near-infrared dye can have a concentration in the coalescent ink such that after the coalescent ink is printed onto the particulate polymer, the amount of near-infrared dye in the particulate polymer is from 0.1 wt % to 1.5 wt % with respect to the weight of the particulate polymer.

The coalescent ink can also include a pigment or dye colorant that imparts a visible color to the coalescent ink. In some examples, the colorant can be present in an amount from 0.5 wt % to 10 wt % in the coalescent ink. In one example, the colorant can be present in an amount from 1 wt % to 5 wt %. In another example, the colorant can be present in an amount from 5 wt % to 10 wt %. However, the colorant is optional and in some examples the coalescent ink can include no additional colorant. These coalescent inks can be used to print 3-dimensional parts that retain the natural color of the build material. Additionally, coalescent ink can include a white pigment such as titanium dioxide that can also impart a white color to the final printed part. Other inorganic pigments such as alumina or zinc oxide can also be used.

In some examples, the colorant can be a dye. The dye may be nonionic, cationic, anionic, or a mixture of nonionic, cationic, and/or anionic dyes. Specific examples of dyes that may be used include, but are not limited to, Sulforhodamine B, Acid Blue 113, Acid Blue 29, Acid Red 4, Rose Bengal, Acid Yellow 17, Acid Yellow 29, Acid Yellow 42, Acridine Yellow G, Acid Yellow 23, Acid Blue 9, Nitro Blue Tetrazolium Chloride Monohydrate or Nitro BT, Rhodamine 6G, Rhodamine 123, Rhodamine B, Rhodamine B Isocyanate, Safranine O, Azure B, or Azure B Eosinate, which are available from Sigma-Aldrich Chemical Company (St. Louis, Mo.). Examples of anionic, water-soluble dyes include, but are not limited to, Direct Yellow 132, Direct Blue 199, Magenta 377 (available from Ilford AG, Switzerland), alone or together with Acid Red 52. Examples of water-insoluble dyes include azo, xanthene, methine, polymethine, or anthraquinone dyes. Specific examples of water-insoluble dyes include Orasol® Blue GN, Orasol® Pink, or Orasol® Yellow dyes available from Ciba-Geigy Corp. Black dyes may include, but are not limited to, Direct Black 154, Direct Black 168, Fast Black 2, Direct Black 171, Direct Black 19, Acid Black 1, Acid Black 191, Mobay Black SP, or Acid Black 2.

In other examples, the colorant can be a pigment. The pigment can be self-dispersed with a polymer, oligomer, or small molecule; or can be dispersed with a separate dispersant. Suitable pigments include, but are not limited to, the following pigments available from BASF: Paliogen®) Orange, Heliogen® Blue L 6901F, Heliogen®) Blue NBD 7010, Heliogen® Blue K 7090, Heliogen® Blue L 7101F, Paliogen®) Blue L 6470, Heliogen®) Green K 8683, or Heliogen® Green L 9140. The following black pigments are available from Cabot: Monarch® 1400, Monarch® 1300, Monarch®) 1100, Monarch® 1000, Monarch®) 900, Monarch® 880, Monarch® 800, or Monarch®) 700. The following pigments are available from CIBA: Chromophtal®) Yellow 3G, Chromophtal®) Yellow GR, Chromophtal®) Yellow 8G, Igrazin® Yellow 5GT, Igralite® Rubine 4BL, Monastral® Magenta, Monastral® Scarlet, Monastral® Violet R, Monastral® Red B, or Monastral® Violet Maroon B. The following pigments are available from Degussa: Printex® U, Printex@ V, Printex® 140U, Printex® 140V, Color Black FW 200, Color Black FW 2, Color Black FW 2V, Color Black FW 1, Color Black FW 18, Color Black S 160, Color Black S 170, Special Black 6, Special Black 5, Special Black 4A, or Special Black 4. The following pigment is available from DuPont: Tipure®) R-101. The following pigments are available from Heubach: Dalamar® Yellow YT-858-D or Heucophthal Blue G XBT-583D. The following pigments are available from Clariant: Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, Novoperm® Yellow HR, Novoperm® Yellow FGL, Hansa Brilliant Yellow 10GX, Permanent Yellow G3R-01, Hostaperm® Yellow H4G, Hostaperm® Yellow H3G, Hostapermr Orange GR, Hostaperm® Scarlet GO, or Permanent Rubine F6B. The following pigments are available from Mobay: Quindo® Magenta, Indofast® Brilliant Scarlet, Quindo® Red R6700, Quindo® Red R6713, or Indofast® Violet. The following pigments are available from Sun Chemical: L74-1357 Yellow, L75-1331 Yellow, or L75-2577 Yellow. The following pigments are available from Columbian: Raven® 7000, Raven® 5750, Raven® 5250, Raven® 5000, or Raven® 3500. The following pigment is available from Sun Chemical: LHD9303 Black. Any other pigment and/or dye can be used that is useful in modifying the color of the coalescent in and/or ultimately, the printed part.

The colorant can be included in the coalescent ink to impart color to the printed object when the coalescent ink is jetted onto the particulate mixture bed. Optionally, a set of differently colored coalescent inks can be used to print multiple colors. For example, a set of coalescent inks including any combination of cyan, magenta, yellow (and/or any other colors), colorless, white, and/or black coalescent inks can be used to print objects in full color. Alternatively or additionally, a colorless coalescent ink can be used in conjunction with a set of colored, non-coalescent inks to impart color. In some examples, a colorless coalescent ink containing a near-infrared dye can be used to coalesce the particulate polymer and a separate set of colored or black or white inks not containing the near-infrared dye can be used to impart color.

The components of the coalescent ink can be selected to give the ink good ink jetting performance and the ability to color the particulate polymer with good optical density. Besides the near-infrared dye and the colorant, if present, the coalescent ink can include a liquid vehicle. Liquid vehicle can include water and one or more co-solvents present in total at from 1 wt % to 50 wt %, depending on the jetting architecture. Further, one or more non-ionic, cationic, and/or anionic surfactant can optionally be present, ranging from 0.01 wt % to 20 wt %. In one example, the surfactant can be present in an amount from 5 wt % to 20 wt %. The liquid vehicle can also include dispersants in an amount from 5 wt % to 20 wt %. The balance of the formulation can be purified water, or other vehicle components such as biocides, viscosity modifiers, materials for pH adjustment, sequestering agents, preservatives, and the like. In one example, the liquid vehicle can be predominantly water. An organic co-solvent can also be included in some examples.

One or more surfactants can also be used, such as alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the coalescent ink can range from 0.01 wt % to 20 wt %. Suitable surfactants can include, but are not limited to, liponic esters such as Tergitol™ 15-S-12, Tergitol™15-S-7 available from Dow Chemical Company, LEG-1 and LEG-7; Triton™ X-100; Triton™ X-405 available from Dow Chemical Company; or sodium dodecylsulfate.

Various other additives can be added to the coalescent ink to optimize the properties of the ink for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, NUOSEPT® (Nudex, Inc.), UCARCIDE™ (Union carbide Corp.), VANCIDE® (R.T. Vanderbilt Co.), PROXEL® (ICI America), or combinations thereof.

Sequestering agents, such as EDTA (ethylene diamine tetra acetic acid), may be included in the coalescent ink to eliminate the deleterious effects of heavy metal impurities, and buffer solutions may be used to control the pH of the ink. From 0.01 wt % to 2 wt %, for example, can be used. Viscosity modifiers and buffers may also be present, as well as other additives to modify properties of the ink as desired. Such additives can be present at from 0.01 wt % to 20 wt %.

In one example, a bed of the particulate mixture including the salt and build material can be formed by introducing the particulate mixture from a supply of the mixture and rolling the mixture in a thin layer using a roller. The coalescent ink can be jetted using a conventional ink jet print head, such as a thermal ink jet (TIJ) printing system. The coalescent ink can penetrate through the layer of particulate mixture so that the printed portion of the layer can coalesce and bond to the layer below. After forming a solid layer, a new layer of loose particulate mixture can be formed, either by lowering the bed or by raising the height of the roller and rolling a new layer of particulate mixture.

The entire particulate mixture bed can be preheated to a temperature below the melting or softening point of the particulate polymer. In one example, the preheat temperature can be from about 10° C. to about 30° C. below the melting or softening point. In another example, the preheat temperature can be within 50° C. of the melting of softening point. In a particular example, the preheat temperature can be from about 160° C. to about 170° C. and the particulate polymer can be nylon 12 powder. In another example, the preheat temperature can be about 90° C. to about 100° C. and the particulate polymer can be thermoplastic polyurethane. Preheating can be accomplished with one or more lamps, an oven, a heated support bed, or other types of heaters. In some examples, the entire bed can be heated to a substantially uniform temperature.

The powder bed can be irradiated with a fusing lamp configured to emit a wavelength that is absorbed by the coalescent ink. In some examples, the lamp can be a commercially available infrared lamp or halogen lamp. The fusing lamp can be a stationary lamp or a moving lamp. For example, the lamp can be mounted on a track to move horizontally across the powder bed. Such a fusing lamp can make multiple passes over the bed depending on the amount of exposure needed to coalesce each printed layer. The fusing lamp can be configured to irradiate the entire particulate mixture bed with a substantially uniform amount of energy. This can selectively coalesce the printed portions with near-infrared absorbing dyes while leaving the unprinted portions of the particulate polymer below the melting or softening point.

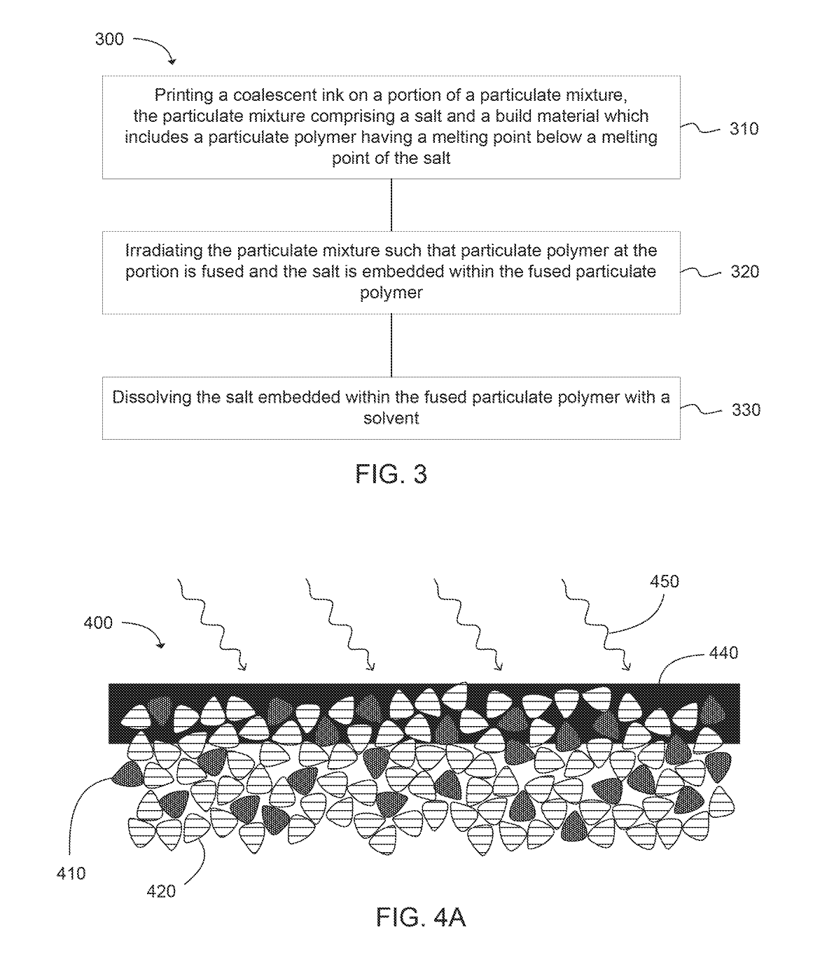

FIG. 3 is a flowchart illustrating a method 300 of forming a porous 3-dimensional printed part. The method includes printing a coalescent ink on a portion of a particulate mixture, the particulate mixture comprising a salt and a build material which includes a particulate polymer having a melting point below a melting point of the salt 310; irradiating the particulate mixture such that particulate polymer at the portion is fused and the salt is embedded within the fused particulate polymer 320; and dissolving the salt embedded within the fused particulate polymer with a solvent 330. The steps of printing and irradiating can be repeated multiple times to form multiple layers prior to the step of dissolving. Typically, the salt can be dissolved after the complete part has been printed.

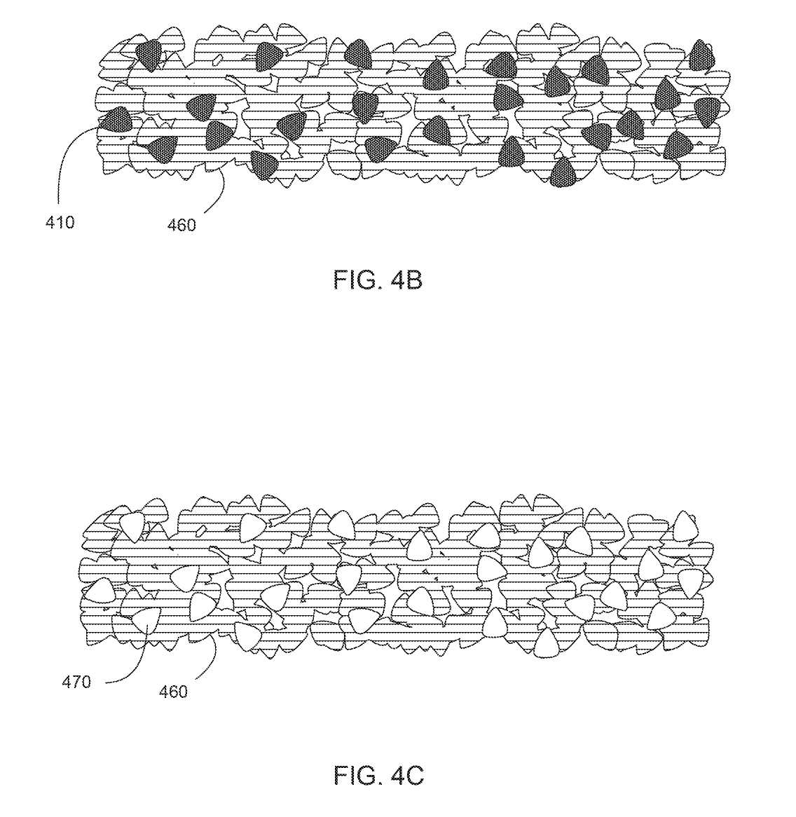

FIGS. 4A-4C illustrate three stages in a process of forming a 3-dimensional printing part. FIG. 4A shows a particulate mixture bed 400 made up of salt particles 410 and polymer particles 420. A coalescent ink 440 is printed onto the particulate mixture bed. The bed is then irradiated with electromagnetic radiation 450 to fuse the polymer particles.

FIG. 4B shows a fused polymer 460 formed from the polymer particles as shown being prepared in FIG. 4A. The salt particles 410 remain embedded in the polymer.

FIG. 4C shows a completed part after dissolving the salt particles. The dissolved salt particles leave behind pores 470 in the fused polymer 460.

Although many of the salt particles in the figures are depicted as being independent and not touching any other salt particles, this is because the figures show a cross-section of only a single layer of the particulate mixture. In three dimensions, adjacent layers of the particulate mixture can include other salt particles that touch the salt particles in the layer depicted in the figures. Thus, a majority of the salt particles can be touching adjacent salt particles. This provides pathways for solvent to reach a majority of the salt particles so that the salt particles can be dissolved.

Many details of the present technology have been described in relation to the Multi Jet Fusion™ process. However, the present technology can be applied any type of 3-dimensional printing that involves a particulate or powder build material. For example, binder jetting 3-dimensional printing systems, selective laser sintering (SLS) systems, selective laser melting (SLM) systems, electron beam melting (EBM) systems, and other 3-dimensional printing methods involving a bed of particulate material can all incorporate the present technology to print porous 3-dimensional parts.

It is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

As used herein, “liquid vehicle” or “ink vehicle” refers to a liquid fluid in which colorant is placed to form an ink. A wide variety of ink vehicles may be used with the systems and methods of the present disclosure. Such ink vehicles may include a mixture of a variety of different agents, including, surfactants, solvents, co-solvents, anti-kogation agents, buffers, biocides, sequestering agents, viscosity modifiers, surface-active agents, water, etc. Though not part of the liquid vehicle per se, in addition to the colorants and/or water-soluble near-infrared dyes, the liquid vehicle can carry solid additives such as polymers, latexes, UV curable materials, plasticizers, salts, etc.

As used herein, “colorant” can include dyes and/or pigments.

As used herein, “dye” refers to compounds or molecules that absorb electromagnetic radiation or certain wavelengths thereof. Dyes can impart a visible color to an ink if the dyes absorb wavelengths in the visible spectrum. Additionally, “near-infrared dye” refers to a dye that absorbs primarily in the near-infrared region of the spectrum, i.e., about 800 nm to about 1400 nm.

As used herein, “pigment” generally includes pigment colorants, magnetic particles, aluminas, silicas, and/or other ceramics, organo-metallics or other opaque particles, whether or not such particulates impart color. Thus, though the present description primarily exemplifies the use of pigment colorants, the term “pigment” can be used more generally to describe not only pigment colorants, but other pigments such as organometallics, ferrites, ceramics, etc. In one specific aspect, however, the pigment is a pigment colorant.

Average particle sizes described herein refer to a number-average particle size. For particles that are roughly spherical in shape, the particle size refers to a diameter of the particle. For particles of other shapes, the particle size refers to the longest dimension of the particle.

As used herein, “soluble,” refers to a material having a solubility of more than 5 wt %.

As used herein, “ink-jetting” or “jetting” refers to compositions that are ejected from jetting architecture, such as ink-jet architecture. Ink-jet architecture can include thermal or piezo architecture. Additionally, such architecture can be configured to print varying drop sizes such as less than 10 picoliters, less than 20 picoliters, less than 30 picoliters, less than 40 picoliters, less than 50 picoliters, etc.

As used herein, the term “substantial” or “substantially” when used in reference to a quantity or amount of a material, or a specific characteristic thereof, refers to an amount that is sufficient to provide an effect that the material or characteristic was intended to provide. The exact degree of deviation allowable may in some cases depend on the specific context.

As used herein, the term “about” is used to provide flexibility to a numerical range endpoint by providing that a given value may be “a little above” or “a little below” the endpoint. The degree of flexibility of this term can be dictated by the particular variable and determined based on the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual 5 values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

### Example

The following illustrates an example of the present disclosure. However, it is to be understood that the following is only illustrative of the application of the principles of the present disclosure. Numerous modifications and alternative compositions, methods, and systems may be devised without departing from the spirit and scope of the present disclosure. The appended claims are intended to cover such modifications and arrangements.

Two porous 3-dimensional printed parts were formed from a particulate mixture having a composition of 80 wt % nylon 12 powder and 20 wt % magnesium chloride. The 3-dimensional printed parts were formed using a Multi Jet Fusion™ process. One part was printed with a black coalescent ink. The other part was printed with multiple colors of coalescent ink. Each part was soaked in static water at room temperature after prepared to remove the salt. Properties of the parts are shown in Table 1.

TABLE 1

| | Black Part | Color Part |
|---|---|---|
| Weight before water soaking (g) | 1.86 | 1.12 |
| Weight after water soaking (g) | 1.52 | 1.01 |
| Water soaking time (h) | 20 | 10 |
| Weight reduction with fully empty pores (%) | 20% | 20% |
| Actual weight reduction (%) | 18.3% | 10% |
| Salt clearance rate (%) | 91.5% | 50% |

This data shows that the salt was almost completely cleared from the black part after 20 hours of soaking. In this particular case, most salt particles in the part were touching or accessible to the dissolving solvent so that the water could reach and dissolve most of the salt particles. The color part was soaked for a shorter time (10 hours) and only half of the salt was removed. It is expected that most of the remaining salt would dissolve after 20 hours of soaking as in the black part. Both parts were strong enough to resist hand bending after removing the salt, indicating that even though the salt was nearly completely removed from the black part, there remained enough physical integrity to be practical for prototyping or for an actual product part.

In accordance with another example, the water soaking time is reduced by circulating the water and/or using higher temperature water.

What is claimed is:

1. A particulate mixture, comprising:
5 wt % to 40 wt % of a salt having an average particle size from 5 μm to 100 μm; and
60 wt % to 95 wt % of a build material for 3-dimensional printing, said build material comprising a particulate polymer having an average particle size from 5 μm to 100 μm and a melting point from 100° C. to 400° C., and which is lower than a melting point of the salt.

2. The particulate mixture of claim 1, wherein the build material further comprises a filler with a higher melting point than the particulate polymer and a particle size ranging from 5 μm to 60 μm.

3. The particulate mixture of claim 1, wherein the salt has a solubility in water of at least 10 g salt/100 mL water at 20° C.

4. The particulate mixture of claim 1, wherein the salt is sodium chloride, magnesium chloride, sodium aluminate, potassium nitrate, magnesium sulfate, sodium sulfate, calcium nitrate, or a mixture thereof.

5. A material set, comprising:
a particulate mixture, comprising:
a salt, and
a build material for 3-dimensional printing comprising a particulate polymer having a melting point below a melting point of the salt; and
a coalescent ink comprising water and a colorant.

6. The material set of claim 5, wherein the particulate mixture has a weight ratio of salt to build material from 1:20 to 2:3.

7. The material set of claim 6, wherein the ratio is sufficient such that a majority of the salt particles are in contact with an adjacent salt particle.

8. The material set of claim 5, wherein the salt has an average particle size from 5 μm to 100 μm.

9. The material set of claim 5, wherein the salt is sodium chloride, magnesium chloride, sodium aluminate, potassium nitrate, magnesium sulfate, sodium sulfate, calcium nitrate, or a mixture thereof.

10. The material set of claim 5, wherein the particulate polymer is nylon 6 powder, nylon 9 powder, nylon 11 powder, nylon 12 powder, nylon 66 powder, nylon 612 powder, polyethylene powder, thermoplastic polyurethane powder, polypropylene powder, polyester powder, polycarbonate powder, polyether ketone powder, polyacrylate powder, polystyrene powder, or a mixture thereof.

11. The material set of claim 5, wherein the build material further comprises a filler with a higher melting point than the particulate polymer and a particle size ranging from 5 μm to 60 μm.

12. The material set of claim 5, wherein the colorant has a peak absorption wavelength from 800 nm to 1400 nm.

13. The material set of claim 5, further comprising a solvent in which the salt is soluble and the build material is insoluble.

14. A method of forming a porous 3-dimensional printed part, comprising:
printing a coalescent ink on a portion of a particulate mixture, said particulate mixture comprising a salt and a build material which includes a particulate polymer having a melting point below a melting point of the salt;
irradiating the particulate mixture such that particulate polymer at the portion is fused and the salt is embedded within the fused particulate polymer; and
dissolving the salt embedded within the fused particulate polymer with a solvent.

15. The method of claim 15, wherein the steps of printing and irradiating are repeated to form multiple layers prior to the step of dissolving.
